(19) United States
(12) Patent Application Publication
(10) Pub. No.: US 2024/0259893 A1
(43) Pub. Date: Aug. 1, 2024

(54) SWITCHING METHOD AND APPARATUS

(71) Applicant: GUANGDONG OPPO MOBILE TELECOMMUNICATIONS CORP., LTD., Dongguan (CN)

(72) Inventor: Xin YOU, Dongguan (CN)

(73) Assignee: GUANGDONG OPPO MOBILE TELECOMMUNICATIONS CORP., LTD., Dongguan (CN)

(21) Appl. No.: 18/634,856

(22) Filed: Apr. 12, 2024

Related U.S. Application Data
(63) Continuation of application No. PCT/CN2021/123955, filed on Oct. 15, 2021.

(51) Int. Cl. H04W 36/00; H04L 5/00; H04W 72/1268; H04W 80/02

(52) U.S. Cl. CPC H04W 36/0058; H04L 5/0051; H04W 72/1268; H04W 80/02

(57) ABSTRACT

A handover method, applied to a terminal device, includes: a reference signal corresponding to a first Transmission/Reception Point (TRP) and/or a second TRP is measured according to measurement configuration information sent by a network device to obtain a measurement result, where the first TRP is connected with the terminal device, and the second TRP is not connected with the terminal device; and the measurement result is sent to the network device.

### CROSS-REFERENCE TO RELATED APPLICATION

This application is a continuation of International Application No. PCT/CN2021/123955 filed on Oct. 15, 2021, the disclosure of which is hereby incorporated by reference in its entirety

### RELATED ART

A handover procedure of User Equipment (UE) in a connected state is supported in a New Radio (NR) system, similar as in a Long Term Evolution (LTE) system.

The handover procedure means that UE using a network service is moved from a source cell to a target cell. At present, the handover procedure in the prior art is based on measurement and reporting performed by the terminal device and configuration from the network device to implement a handover. However, there will be multiple signaling interactions in this procedure, which will bring a large delay.

Therefore, the current handover procedure has the problem of the large delay.

### SUMMARY

The present disclosure relates to the field of communications, in particular to, a handover method and a handover device.

Embodiments of the present disclosure provide a handover method and a handover device to solve the problem of the large delay in the handover procedure.

In a first aspect, the embodiment of the present disclosure provides a handover method including that: a reference signal corresponding to a first Transmission/Reception Point (TRP) and/or a second TRP is measured according to measurement configuration information sent by a network device to obtain a measurement result, where the first TRP is connected with the terminal device, and the second TRP is not connected with the terminal device; and the measurement result is sent to the network device.

In a second aspect, the embodiment of the present disclosure provides a handover device including: a processor, a memory and a transceiver. The memory is configured to store computer-executable instructions. The processor is configured to invoke and run the computer-executable instructions stored in the memory to perform operations of: measuring, according to measurement configuration information sent by a network device, a reference signal corresponding to a first Transmission/Reception Point (TRP) and/or a second TRP to obtain a measurement result, wherein the first TRP is connected with the terminal device, and the second TRP is not connected with the terminal device; and sending, through the transceiver, the measurement result to the network device.

In a third aspect, the embodiment of the present disclosure provides a handover device including: a processor, a memory and a transceiver. The memory is configured to store computer-executable instructions. The processor is configured to invoke and run the computer-executable instructions stored in the memory to perform operations of: sending measurement configuration information to a terminal device, wherein the measurement configuration information is used for the terminal device to measure a reference signal corresponding to a first Transmission/Reception Point (TRP) and/or a second TRP, the first TRP is connected with the terminal device, and the second TRP is not connected with the terminal device; and receiving, through the transceiver, a measurement result sent by the terminal device.

### BRIEF DESCRIPTION OF THE DRAWINGS

FIG. 1 is a schematic diagram of a communication scenario according to an embodiment of the present disclosure.

FIG. 2 is a schematic diagram of a layout of a terminal device and a TRP according to an embodiment of the present disclosure.

FIG. 3 is a schematic diagram of UE performing a handover between different cells according to an embodiment of the present disclosure.

FIG. 4 is a flowchart of a 4-step Random Access Channel (RACH) according to an embodiment of the present disclosure.

FIG. 5 is a flowchart of a 2-step RACH according to an embodiment of the present disclosure.

FIG. 6 is a flowchart of a handover method according to an embodiment of the present disclosure.

FIG. 7 is a second flowchart of a handover method according to an embodiment of the present disclosure.

FIG. 8 is a schematic diagram of a combination of measurement and reporting according to an embodiment of the present disclosure.

FIG. 9 is a third flowchart of a handover method according to an embodiment of the present disclosure.

FIG. 10 is a second schematic diagram of a combination of measurement and reporting according to an embodiment of the present disclosure.

FIG. 11 is a fourth flowchart of a handover method according to an embodiment of the present disclosure.

FIG. 12 is a third schematic diagram of a combination of measurement and reporting according to an embodiment of the present disclosure.

FIG. 13 is a fifth flowchart of a handover method according to an embodiment of the present disclosure.

FIG. 14 is a fourth schematic diagram of a combination of measurement and reporting according to an embodiment of the present disclosure.

FIG. 15 is a sixth flowchart of a handover method according to an embodiment of the present disclosure.

FIG. 16 is a schematic diagram of an implementation flow of a Media Access Control (MAC) layer according to an embodiment of the present disclosure.

FIG. 17 is a seventh flowchart of a handover method according to an embodiment of the present disclosure.

FIG. 18 is an eighth flowchart of a handover method according to an embodiment of the present disclosure.

FIG. 19 is a schematic structural diagram of a handover device according to an embodiment of the present disclosure.

FIG. 20 is a schematic structural diagram of a handover device according to an embodiment of the present disclosure.

FIG. 21 is a schematic structural diagram of a terminal device according to an embodiment of the present disclosure.

FIG. 22 is a schematic structural diagram of a network device according to an embodiment of the present disclosure.

### DETAILED DESCRIPTION

In order to make the technical schemes of the present disclosure better understood, the following related concepts and related technologies involved in the present disclosure are introduced.

The terminal device is a device including a wireless transceiver function and may cooperate with a network device to provide communication services for users. Specifically, the terminal device may be UE, an access terminal, a subscriber unit, a subscriber station, a mobile station, a remote station, a remote terminal, a mobile device, a user terminal, a terminal, a wireless communication device, a user agent, or a user device. For example, the terminal device may be a cellular phone, a cordless phone, a Session Initiation Protocol (SIP) phone, a Wireless Local Loop (WLL) station, a Personal Digital Assistant (PDA), a handheld device having a wireless communication function, a computing device or other processing devices connected with a wireless modem, a vehicle-mounted device, a wearable device, a terminal device in a future 5G network or a network after 5G, etc.

The network device may be a device used for communicating with a terminal device, for example, a Base Transceiver Station (BTS) in a Global System for Mobile Communications (GSM) system or Code Division Multiple Access (CDMA) communication system, a base station (NodeB, NB) in a Wideband Code Division Multiple Access (WCDMA) system, an evolutional Node B (eNB or eNodeB) in an LTE system; or the network device may be a relay station, an access point, or a vehicle-mounted device, a wearable device, a network side device in the future 5G network or a network after 5G, or a network device in the future evolutional Public Land Mobile Network (PLMN) network, etc.

The Control Resource Set (CORESET) is a type of time-frequency resource set introduced in the NR, and the UE detects a Physical Downlink Control Channel (PDCCH) in a corresponding control resource set. The control resource set consists of a set of Resource Element Groups (REGs).

The network device involved in the embodiments of the present disclosure may also be referred to as a Radio Access Network (RAN) device. The RAN device is connected with the terminal device and configured to receive data from the terminal device and send the data to a core network device. The RAN device corresponds to different devices in different communication systems. For example, the RAN device corresponds to a base station and a base station controller in the 2G system, the RAN device corresponds to a base station and a Radio Network Controller (RNC) in the 3G system, the RAN device corresponds to an evolutional Node B (eNB) in the 4G system, and the RAN device corresponds to an access network device (e.g. a gNB, a Centralized Unit (CU), a Distributed Unit (DU)) in the 5G system such as the NR system.

The beam may be embodied as a spatial filter in the NR protocol, or may be referred as a spatial filter or a spatial parameter. A beam used for sending a signal may be referred to as a transmission beam (Tx beam), a spatial domain transmit filter or a spatial domain transmit parameter. A beam used for receiving the signal may be referred to as a reception beam (Rx beam), a spatial domain receive filter or a spatial domain receive parameter.

For example, the beam may be understood as a spatial resource and may be a transmission or reception pre-coded vector having an energy transmission directivity. Moreover, the transmission or reception pre-coded vector may be identified by index information, and the index information may correspond to a resource identifier (ID) configured for the terminal. For example, the index information may correspond to an ID or a resource of a configured Synchronization Signal Block (SSB); the index information may also correspond to an ID or a resource of a configured Channel State Information Reference Signal (CSI-RS); the index information may also be an ID or a resource of a correspondingly configured uplink Sounding Reference Signal (SRS). Optionally, the index information may also be index information explicitly or implicitly carried in a signal or channel carried through a beam. The energy transmission directivity may mean a certain spatial directivity of a pre-coded signal that is obtained by pre-coding a signal to be sent through the pre-coded vector, and the receiving power is better when the signal pre-coded by the pre-coded vector is received, such as, satisfying a Signal to Noise Ratio (SNR) for reception and demodulation, etc. The energy transmission directivity may also mean that there are different receiving powers when the same signals sent from different spatial locations are received through the pre-coded vector. Optionally, the same communication device (such as a terminal device or a network device) may have different pre-coded vectors, and different devices may also have different pre-coded vectors, i.e. corresponding to different beams. With respect to the configuration or capability of the communication device, one communication device may use one or more of multiple different pre-coded vectors at a same moment, i.e. a beam or multiple beams may be formed simultaneously.

Based on different transmission directions, the beams may be divided into the Tx beam and the Rx beam. The Tx beam may be a distribution of signal strengths formed in different directions in the space after a signal is transmitted through the antenna, and the Rx beam may be a distribution of signal strengths in different directions in the space of a wireless signal received from the antenna.

It is to be understood that the embodiments of the beam in the NR protocol enumerated above are by way of example only and should not constitute any limitations to the present disclosure. The present disclosure does not exclude the possibility of defining other terms in a future protocol to express the same or similar meanings.

In addition, the beam may be a wide beam, or a narrow beam, or another type of beam. The technology for forming the beam may be a beamforming technology or other technology. The beamforming technology may specifically be the digital beamforming technology, the analog beamforming technology or the hybrid digital/analog beamforming technology. Different beams may be considered as different resources. The same information or different information may be sent through different beams.

Optionally, multiple beams having the same or similar communication characteristics are treated as one beam. One beam may include one or more antenna ports for transmitting data channels, control channels, sounding signals, etc. The one or more antenna ports forming one beam may also be regarded as an antenna port set.

In addition, it is to be appreciated that in the description of the present disclosure, the words “first”, “second” and the like are used only for the purpose of distinguishing description, and cannot be understood as indicating or implying the relative importance, indicating or implying the order, and also cannot be understood as indicating or implying the association between similar nouns.

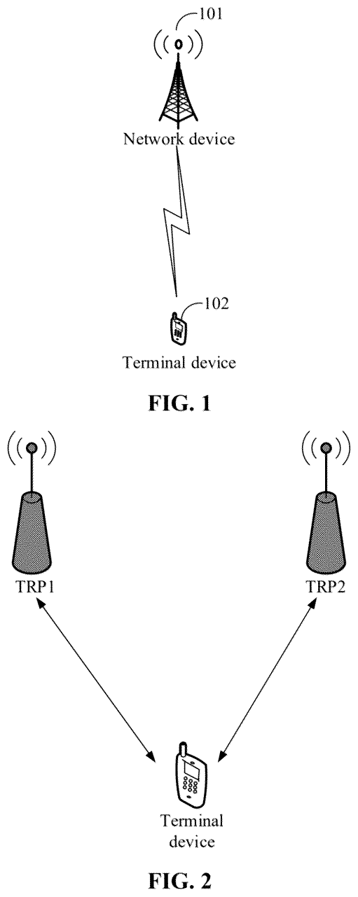

Hereinafter, a scenario to which the communication method in the present disclosure is applied will be described with reference to FIG. 1.

FIG. 1 is a schematic diagram of a communication scenario according to an embodiment of the present disclosure. With reference to FIG. 1, a network device 101 and a terminal device 102 are included, and the network device 101 may perform wireless communication with the terminal device 102.

It is to be understood that the technical schemes in the embodiments of the present disclosure may be applied to the New Radio (NR) communication technology. The NR is the new generation wireless access network technology and may be applied to the future evolutional network, such as the 5th Generation (5G) Mobile Communication system in the future. The schemes in the embodiments of the present disclosure may also be applied to other wireless communication networks such as the Wireless Fidelity (WIFI) and the Long Term Evolution (LTE), and corresponding names in the schemes may also be replaced by the names of corresponding functions in other wireless communication networks.

The network architecture and the service scenario described in the embodiments of the present disclosure are intended to more clearly explain the technical schemes in the embodiments of the present disclosure and do not constitute a limitation to the technical schemes provided by the embodiments of the present disclosure. Those of ordinary skill in the art may see that with the evolution of the network architecture and the emergence of new service scenarios, the technical schemes provided by the embodiments of the present disclosure are equally applicable to similar technical problems.

At present, the worldwide research and development of the 5G has entered a new stage. The 3rd Generation Partnership Project (3GPP) has basically identified three scenarios of the 5G: Enhanced Mobile Broadband (eMBB), Massive Machine Type Communication (Massive MTC), and Ultra-Reliable and Low Latency Communication (URLLC).

As to the spectra planned by the 3GPP 5G, a large part of the spectra is as high as 30 GHz, 70 GHz or even 100 GHz. The multi-antenna technology is very suitable to be used at such high spectra to improve coverage and capacity. Therefore, the massive Multiple-Input Multiple-Output (MIMO) is undoubtedly one of the important means for improving the spectrum efficiency of the 5G. In the 3GPP conference, the beamforming has been discussed as an important technical feature of 5G.

However, in the case of the high spectrum, due to a limited coverage of a network node (such as a base station), the coverage radius of the cell will be very small according to traditional definition of the cell. Therefore, the concept of the TRP is generally introduced into the 5G, and the TRP is equivalent to a traditional base station. However, in some cases, a cell may not be covered by only one TRP, but be jointly covered by multiple TRPs, thus the coverage radius of the cell is increased, and the continuous handovers performed by the terminal device on the cells are greatly reduced.

The TRP is described below with reference to FIG. 2. FIG. 2 is a schematic diagram of a layout of a terminal device and a TRP according to an embodiment of the present disclosure.

As shown in FIG. 2, there are two TRPs marked as TRP1 and TRP2 respectively. Each TRP may correspond to multiple beam paths, and the TRPs may communicate with each other. The communication between the TRPs may be performed by the wired connection or the wireless connection. In some cases, if two TRPs are far away from each other, the communication may also be performed by relay, which specifically depends on the actual deployment of the scenario.

In one possible implementation, the TRP1 may serve as a serving TRP (equivalent to a base station) configured to send a channel to a terminal device, and the TRP2 may also serve as a serving TRP (equivalent to a base station) configured to send the channel to the terminal device.

On the basis of the above-described contents, the handover procedure of cell handover is described below. The cell handover is a channel handover in order to maintain uninterrupted communication of the UE when the UE moves from one cell to another cell in the wireless communication system. The cell is the base station or the coverage of the base station.

Similar to the LTE system, the handover procedure of the UE in the connected state is supported in the NR system, and the handover procedure of the UE in the connected state may be performed under some conditions. For example, when the UE using the network service moves from one cell to another cell, or due to the adjustment of wireless transmission service load, activation operation maintenance, equipment failure and other reasons, the system needs to transfer a communication link between the UE and an original cell to a new cell, i.e., performing the handover procedure, in order to ensure continuity of the communication and quality of the service.

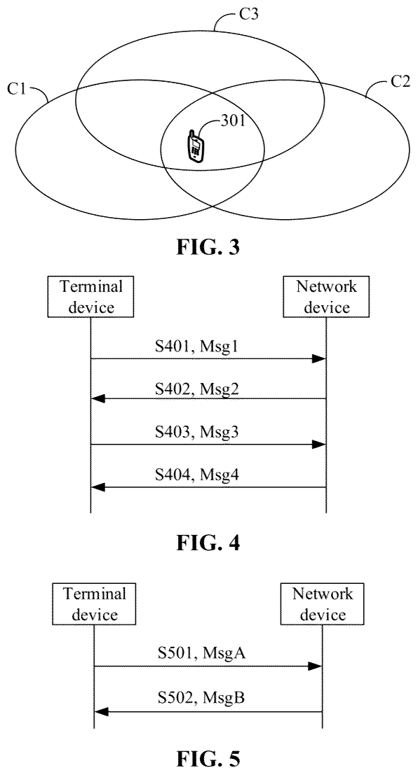

For example, the handover procedure may be understood with reference to FIG. 3. FIG. 3 is a schematic diagram of UE performing a handover between different cells according to an embodiment of the present disclosure.

As shown in FIG. 3, the terminal device 301 is located within a common area covered by three different cells C1, C2 and C3. It is assumed that the cell that the terminal device 301 currently accesses is the cell C1, when the specific condition described above is satisfied, the terminal device 301 may, for example, switch from the cell C1 into the cell C2 or from the cell C1 into the cell C3. The cell C1 is the source cell, i.e., the cell where the terminal device is located before the handover, and cell C2 or cell C3 is the target cell, i.e., the cell where the terminal device is located after the handover.

The handover procedure described above may be, for example, an intra-station handover, i.e., the source cell and the target cell belong to a same network device. The source cell and the target cell may be a same cell or different cells. Alternatively, the handover procedure may be inter-station handover, i.e., the source cell and the target cell belong to different network devices. Whether the source cell and the target cell belong to a same network device or different network devices is not limited in the embodiments of the present disclosure.

On the basis of the handover related contents described above, the handover procedure is introduced by taking the handover procedure based on Xn interface as an example. The Xn interface is a network interface between Next Generation Radio Access Network (NG-RAN) nodes, and the NG-RAN nodes may include, for example, a 5G base station (gNB) and an upgraded 4G base station (ng-eNB) supporting the eLTE.

The whole handover procedure may be divided into the following three stages.

(1) A stage of handover preparation includes measurement control and measurement reporting, handover request and handover acknowledgement. For example, the source base station may configure the measurement report of the UE, and the UE sends the measurement report to the source base station according to a predetermined measurement rule; the source base station determines whether the UE needs the handover according to the measurement report and Radio Resource Management (RRM) information. When the handover is needed, the source base station sends the handover request to the target base station; and the target base station performs admission control based on received Quality of Service (QoS) information, and returns a handover acknowledgement message.

The handover acknowledgement message contains a handover command generated by the target cell, and the source cell is not allowed to perform any modification to the handover command generated by the target cell, and the source cell directly forwards the handover command to the UE.

It is to be understood that the source cell corresponds to the source network device (e.g. the source base station), and the target cell corresponds to the target network device (e.g. the target base station).

(2) In a stage of handover execution, the UE performs the handover procedure immediately after the handover command is received. That is to say, the UE is disconnected from the source cell and is connected with the target cell (such as performing the random access), and sends Radio Resource Control (RRC) handover completion message to the target base station, etc. This stage may also include Sequence Number (SN) status transfer and data forwarding.

(3) A stage of handover completion includes a path switch between the target cell and the Access and Mobility Management Function (AMF) network element as well as the User Plane Function (UPF) network element, to release the UE context of the source base station.

Based on the above introduction, it may be determined that in the handover procedure, the UE needs to send the handover completion message to the target cell, therefore the UE needs to acquire the corresponding uplink resources, so as to send the handover completion message to the target cell based on the uplink resources.

In one possible implementation, the traditional handover procedure often includes the random access process. That is to say, after the handover message is received, the terminal device performs, according to the relevant information of the target cell contained in the handover message (such as the physical cell ID of the target cell, frequency information, information about the random access resource required for handover to the target cell, etc.), the random access process to access the target cell, and then sends the handover completion message to the target cell.

The random access procedure will be briefly described as follows. The random access is a process where the terminal device starts to send the random access preamble index to the network device that it attempts to access, until a connection between the terminal device and the network device is established. The random access process may occur, for example, in the handover RRC re-establishment, etc.

The random access involved in the embodiments of the present disclosure may include four-step random access (also referred to as a four-step random access channel, or a 4-step RACH) and two-step random access (also referred to as a two-step random access channel, or a 2-step RACH). The procedures of the 4-step RACH and the 2-step RACH are respectively described in detail below for ease of understanding.

The four-step random access will be briefly described as follows according to FIG. 4. FIG. 4 is a flowchart of the 4-step RACH according to an embodiment of the present disclosure. As shown in FIG. 4, the four-step random access process may specifically include operations S401 to S404.

In operation S401, a terminal device sends an Msg1 to a network device.

The Msg1 is used for transmitting a random access preamble. For example, the terminal device sends a random access preamble (or random access preamble sequence) index to the network device through a Physical Random Access Channel (PRACH).

In operation S402, the network device sends an Msg2 to the terminal device.

The Msg2 may include a random access response. The random access response may include a Timing Advance (TA) of the response, an UpLink (UL) grant, a temporary Cell-Radio Network Temporary Identifier (C-RNTI), etc.

In operation S403, the terminal device sends an Msg3 to the network device.

The Msg3 is the first scheduled transmission in the random access procedure. For example, the terminal device sends, based on the received random access response, a message/data (such as an RRC setup request message), on a UL grant resource allocated by the network device. The RRC setup request message may contain ID information of the terminal device. The ID information may be, for example, a temporary C-RNTI as described above.

In operation S404, the network device sends an Msg4 to the terminal device.

The Msg4 is used for indicating whether the terminal device successfully accesses the network device. For example, after the network device receives the message/data sent by the terminal device on the allocated UL grant resource, if there is no conflict (or no contention), the network device sends a contention resolution message to the terminal device. For example, the network device sends the RRC setup message to the terminal device. Then, the terminal device may communicate with the network device.

The two-step random access will be briefly described as follows according to FIG. 5. FIG. 5 is a flowchart of the 2-step RACH according to an embodiment of the present disclosure. As shown in FIG. 5, the two-step random access process may specifically include operations S501 to S502.

In operation S501, the terminal device sends an MsgA to the network device.

The MsgA is used for transmitting a random access preamble. For example, the terminal device sends a random access preamble index (or a random access preamble sequence) to the network device through the PRACH. In a contention free random access process, the random access preamble index is allocated in advance by the network device to the terminal device. In other words, the random access preamble index is dedicated.

In operation S502, the network device sends an MsgB to the terminal device.

The MsgB is used for indicating whether the terminal device successfully accesses the network device. For example, the network device sends a random access response to the terminal device. The random access response may include a TA of the response, UL grant, etc.

It is to be noted that the UL grant may specifically include at least one of: a time-frequency resource, a Modulation and Coding Scheme (MCS), a New Data Indication (NDI), a moment (such as a subframe or a slot) when an uplink transmission is initiated, or an uplink scheduling interval. The time-frequency resource contained in the UL grant may specifically be a time-frequency position of an uplink resource scheduled through the UL grant. The uplink resource scheduled by the UL grant may be, for example, a PUSCH resource.

Based on the contents of the random access procedures described above, it may be determined that the UE may acquire the uplink resource through initiating the random access procedure, so as to send the handover completion message to the target cell, and may also acquire the TA through initiating the random access procedure, so as to implement synchronization with the target cell.

On the basis of the above introduction, the Beam Failure Recovery (BFR) is described as follows.

As one of the key technologies of the 5G mobile communication system, the beamforming technology may effectively combat path loss, thus improving the coverage and the capacity of the system. Generally, the better the alignment between the beam and the UE, the greater the signal gain provided by the beam. However, in a millimeter wave system, the beam misalignment between the gNB and the UE may be caused by sudden channel fluctuation, unexpected obstacle interruption, UE rotation and other factors. In this case, the UE is unable to decode any Downlink (DL) signals and/or the gNB is unable to decode any Uplink (UL) signals due to the beam misalignment between the gNB and the UE. If these failures occur repeatedly, the UE will fall into a Radio Link Failure (RLF). Therefore, it is necessary to define and study beam recovery to avoid the frequent RLFs caused by the beam failure. Accordingly, in the NR Rel-15, the BFR is standardized for the Primary Cell (PCell) or the Primary Secondary Cell (PSCell). The PCell and PSCell are collectively referred to as special cells (SpCells), and specifically be the PCell of a Master Cell group (MCG) or a PSCell of a Secondary Cell group (SCG).

The main principle of the beam failure recovery is to help the gNB or the UE to adjust the current faulty beam to other available beam according to a result of the beam measurement, so as to avoid the frequent RLFs caused by the beam misalignment. The reason why the NR supports the UE in triggering the beam failure recovery is mainly considering that an uplink beam failure event is detected by the gNB, so the beam recovery may be implemented by triggering uplink beam management through the gNB. For the downlink beam, the beam failure event is detected by the UE. Because the UE may have the latest result of the beam measurement, the beam recovery procedure will be triggered by the UE. Generally speaking, the beam failure recovery mainly is the downlink beam failure recovery.

The UE may inform, in a manner of the random access, the base station which downlink Tx beam to use to send the RAR, so as to recover the downlink beam. The random access preamble of the NR random access (RA) is configured per SSB. The SSB is specifically a Synchronization Signal and PBCH block, and is composed of three parts: a Primary Synchronization Signal (PSS), a Secondary Synchronization Signal (SSS) and a Physical Broadcast Channel (PBCH).

The UE firstly selects the SSB/Channel State Information Reference Signal (CSI-RS) index satisfying a threshold by comparing the Reference Signal Receiving Powers (RSRPs), and there is a link relationship between the SSB and the CSI-RS; and the UE uses the corresponding preamble and the Physical Random Access Channel (PRACH) resource on the SSB to send the Msg1. That is to say, after the preamble is received, the gNB knows which SSB is used for feed backing the RAR.

The overall procedure of the BFR includes the following steps.

1. In the beam failure detection, the physical layer determines, through measuring the CSI-RS and/or SS/PBCH block, whether quality of a corresponding PDCCH satisfies a predetermined/configured threshold (e.g., hypothetical Block Error Rate (BLER) performance is poor than the threshold).

If it is detected that the threshold is not satisfied, it may be determined that the beam failure is detected, and then the physical layer reports a beam failure instance to the Media Access Control (MAC) layer.

For an MAC entity, whenever the physical layer reports one beam failure instance, the UE will increment the counter BFI_COUNTER by 1 and restart the beam failure detection timer (beamFailureDetectionTimer). If the BFI_COUNTER reaches the maximum value during the running of the beamFailureDetectionTimer, it is considered that a beam failure occurs, and a random access procedure is initiated

2. In the new candidate beam identification, the UE selects a new beam satisfying the predetermined/configured threshold through the CSI-RS and/or SSB (SS/PBCH block).

3. If the new beam satisfying the condition is not selected, the new beam is selected by adopting the contention-based random access procedure.

4. In the beam failure recovery request transmission, the UE selects a PRACH corresponding to a new beam to initiate the transmission, or reports the selected new beam through the Physical Uplink Control Channel (PUCCH).

5. The UE monitors a gNB response to a beam failure recovery request, i.e., the UE detects the response of the network.

At present, the BFR of the SCell is introduced in R16, and occurrence of the beam failure in the SCell is indicated by reporting the BFR MAC CE.

Based on the above introduction, it may be determined that the existing handover is based on the measurement and reporting performed by the terminal device and the configuration from the network device. There will be multiple signaling interactions in the existing handover, which will bring the large delay, so the handover manner in the prior art will have the problem of the large delay.

In view of the problems in the prior art, the present disclosure proposes the following technical idea: a bottom layer-based handover is one of the solutions for reducing the handover delay. Therefore, the present disclosure proposes a bottom layer-based handover method.

On the basis of the above introduction, the handover method provided by the present disclosure is described below with reference to FIG. 6. FIG. 6 is a flowchart of a handover method according to an embodiment of the present disclosure.

As shown in FIG. 6, the method includes operations S601 to S602.

In operation S601, a reference signal corresponding to a first Transmission/Reception Point (TRP) and/or a second TRP is measured according to measurement configuration information sent by a network device to obtain a measurement result, where the first TRP is connected with the terminal device, and the second TRP is not connected with the terminal device.

In this embodiment, the network device may configure at least one TRP for the terminal device. Different TRPs may belong to the same cell or different cells, and different TRPs may have the same Physical-layer Cell Identifier (PCI) or different PCIs. The TRPs may be distinguished by different reference signal sets, or by different resources, such as different coresets/coreset pools, different Hybrid Automatic Repeat Request (HARQ) processes or different protocol stacks (e.g., SDAP/PDCP/RLC/MAC/PHY).

The SDAP is an abbreviation of Service Data Adaptation Protocol, the PDCP is an abbreviation of Packet Data Convergence Protocol, the RLC is an abbreviation of Radio Link Control, and PHY is an abbreviation of Physical.

In the actual implementation process, the specific configuration information and the distinguishing manner of the TRPs may be selected and set according to the actual requirements, which will not be limited in the embodiment.

In this embodiment, the terminal device may maintain the connection with at least one first TRP at the same moment, so it is to be appreciated that the network device may configure multiple TRPs for the terminal device, the first TRP in this embodiment is the TRP connected with the terminal device at the current moment, and the second TRP is the TRP not connected with the terminal device at the current moment.

In one possible implementation, the terminal device in this embodiment may receive the measurement configuration information sent by the network device. The measurement configuration information may be used for measuring the reference signal corresponding to the first TRP and/or the second TRP. The measurement configuration information may include for example: a set of reference signals to be measured, IDs of the reference signals to be measured, type information of the reference signals to be measured, and the measurement configuration information may also include, for example, a trigger condition for the measurement, a condition for measurement reporting, etc. The specific implementation of the measurement configuration information is not limited in the embodiment. Any configuration information used for indicating measurement of the first TRP and/or the second TRP may be used as the measurement configuration information in this embodiment.

Therefore, the terminal device in this embodiment may measure the reference signal corresponding to the first TRP and/or the second TRP according to the measurement configuration information sent by the network device, thereby obtaining the measurement result. In one possible implementation, the measurement result may include, for example, Reference Signal Receiving Power (RSRP)/Reference Signal Receiving Quality (RSRQ)/Signal to Interference plus Noise Ratio (SINR) or Block Error Rate (BLER) of the beam/reference signal. The BLER is a percentage of error blocks in all transmitted blocks. In an actual implementation process, the specific implementation of the measurement result may depend on the specific configuration of the measurement configuration information, and the specific implementation of the measurement result is not limited in the embodiment.

In operation S602, the measurement result or handover indication information is sent to the network device, where the handover indication information is used for indicating that the terminal device switches, according to the measurement result, a TRP connected with the terminal device from the first TRP into the second TRP.

After the network device obtains the measurement result, in one possible implementation, the terminal device may, for example, send the measurement result to the network device, so that the network device determines whether the first TRP is required to be switched into the second TRP according to the measurement result; and then the terminal device may, for example, switch the first TRP connected with the terminal device from the first TRP into the second TRP according to the indication from the network device.

In another possible implementation, after the terminal device obtains the measurement result, for example, the physical layer or the MAC layer of the terminal device may trigger, by itself, the switching of the TRP connected with the terminal device from the first TRP into the second TRP according to the measurement result. After triggering, the terminal device may generate the handover indication information and send the handover indication information to the network device. The handover indication information is used for informing the network device that the terminal device switches the connected TRP from the first TRP into the second TRP.

It is to be understood that, in the implementation process above, the terminal device may measure the reference signal corresponding to the first TRP and/or the second TRP based on the measurement configuration information, and then the network device or the terminal device may implement the handover of the terminal device from the first TRP into the second TRP based on the measurement result measured by the measurement. In this implementation process, there is no interaction procedure of the multiple pieces of signaling described above, so that the handover delay may be effectively reduced.

The handover method provided by the embodiment of the present disclosure includes that: a reference signal corresponding to a first Transmission/Reception Point (TRP) and/or a second TRP is measured according to measurement configuration information sent by a network device to obtain a measurement result, where the first TRP is connected with the terminal device, and the second TRP is not connected with the terminal device; and the measurement result or handover indication information is sent to the network device, where the handover indication information is used for indicating that the terminal device switches, according to the measurement result, a TRP connected with the terminal device from the first TRP into the second TRP. The first TRP and/or the second TRP configured by the network device are measured through the measurement configuration information to obtain the measurement result. And then, the network device or the terminal device implement, based on the measurement result, the handover of the terminal device from the first TRP into the second TRP when corresponding conditions are satisfied, so that the interaction procedure of multiple pieces of signaling can be effectively avoided, thereby reducing the handover delay.

On the basis of the above embodiment, the handover procedure described above may, for example, be triggered by the PHY layer of the terminal device or may also be triggered by the MAC layer of the terminal device, and the two implementations are described respectively below.

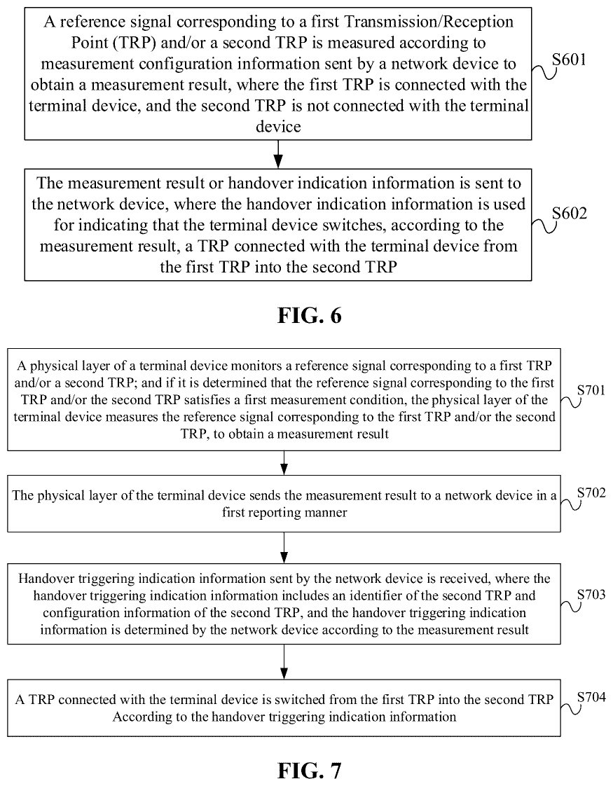

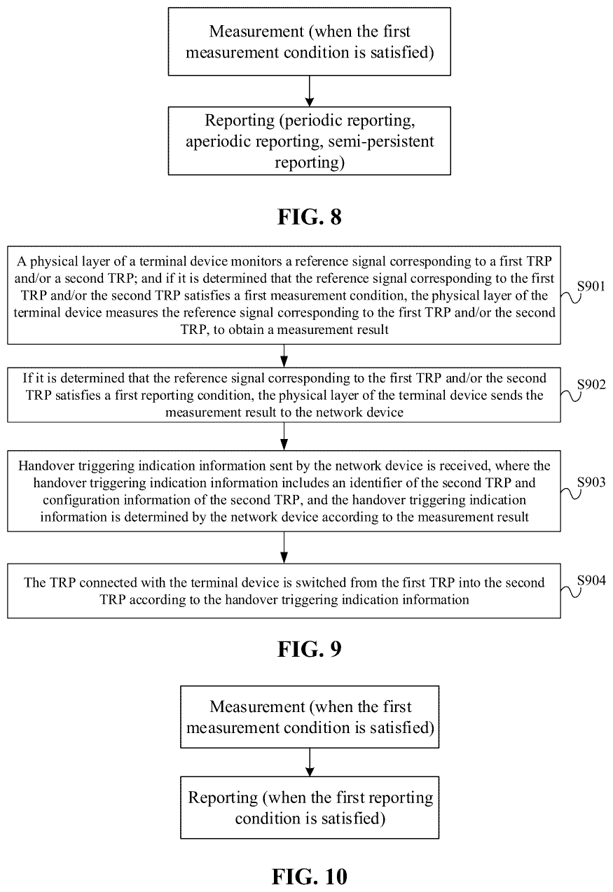

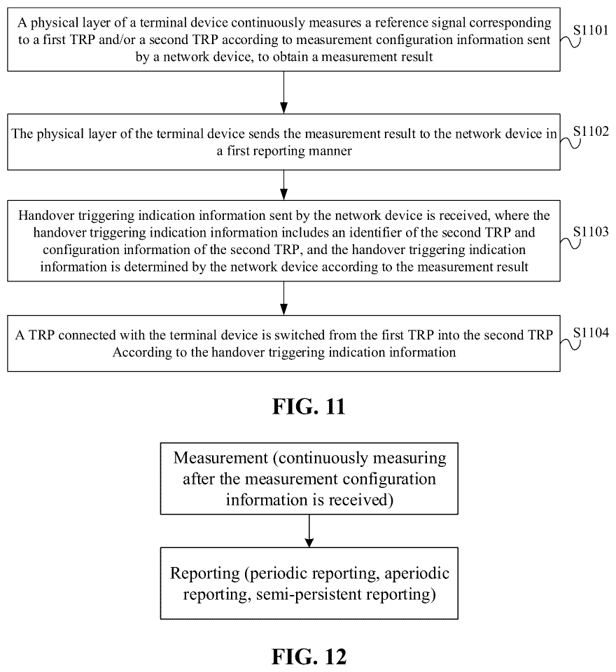

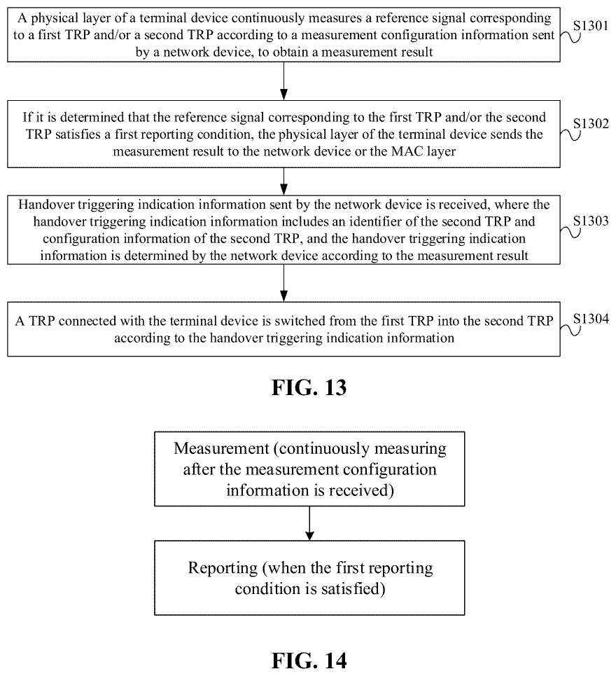

The implementation that the handover is triggered by the physical layer is described below with reference to FIG. 7 to FIG. 14. FIG. 7 is a second flowchart of a handover method according to an embodiment of the present disclosure. FIG. 8 is a schematic diagram of a combination of measurement and reporting according to an embodiment of the present disclosure. FIG. 9 is a third flowchart of a handover method according to an embodiment of the present disclosure. FIG. 10 is a second schematic diagram of a combination of measurement and reporting according to an embodiment of the present disclosure. FIG. 11 is a fourth flowchart of a handover method according to an embodiment of the present disclosure. FIG. 12 is a third schematic diagram of a combination of measurement and reporting according to an embodiment of the present disclosure. FIG. 13 is a fifth flowchart of a handover method according to an embodiment of the present disclosure. FIG. 14 is a fourth schematic diagram of a combination of measurement and reporting according to an embodiment of the present disclosure.

Based on the above introduction, it may be determined that the handover procedure may include the measurement and the reporting. In this embodiment, there are different implementations for the measurement and the reporting, and moreover, the implementations for the measurement and the implementations for the reporting may be combined accordingly. Several different implementations for the measurement and the reporting are introduced below.

First of all, one possible implementation of the measurement and the reporting triggered by the physical layer is introduced with reference to FIG. 7 and FIG. 8.

As shown in FIG. 7, when the measurement and the reporting are triggered by the physical layer, the method includes operations S701 to S704.

In operation S701, a physical layer of a terminal device monitors a reference signal corresponding to a first TRP and/or a second TRP; and if it is determined that the reference signal corresponding to the first TRP and/or the second TRP satisfies a first measurement condition, the physical layer of the terminal device measures the reference signal corresponding to the first TRP and/or the second TRP, to obtain a measurement result.

In this embodiment, the measurement configuration information may include, for example, the first measurement condition. The first measurement condition is a condition indicating whether to measure the reference signal corresponding to the first TRP and/or the second TRP.

For example, the physical layer of the terminal device may monitor the reference signal corresponding to the first TRP and/or the second TRP, and then determines whether the reference signal corresponding to the first TRP and/or the second TRP satisfies the first measurement condition. If it is determined that the first measurement condition is satisfied, the physical layer of the terminal device may measure the reference signal corresponding to the first TRP and/or the second TRP to obtain the measurement result.

In one possible implementation, the first measurement condition may, for example, includes a first threshold, and the fact that the reference signal corresponding to the first TRP and/or the second TRP satisfies the first measurement condition, for example, may include at least one of:
a measured value of the reference signal corresponding to the first TRP and/or the second TRP satisfies the first threshold; or
a difference between a measured value of the reference signal corresponding to the first TRP and a measured value of the reference signal corresponding to the second TRP satisfies the first threshold.

The measured value of the reference signal herein may for example be the specific value of the RSRP/RSRQ/SINR or BLER described above. And the fact that the difference between the measured value of the reference signal corresponding to the first TRP and the measured value of the reference signal corresponding to the second TRP described herein satisfies the first threshold may be understood as that the second TRP is better than the first TRP to a certain extent.

When the reference signal is measured according to the first measurement condition, in another possible implementation, after it is determined that the reference signal corresponding to the first TRP and/or the second TRP satisfies the first measurement condition, a duration where the reference signal corresponding to the first TRP and/or the second TRP satisfies the first measurement condition may be further acquired. If the duration where the first measurement condition is satisfied is greater than or equal to the first preset duration, the physical layer of the terminal device measures the reference signal corresponding to the first TRP and/or the second TRP.

Moreover, it is also to be noted that satisfying the first threshold described in this embodiment, for example, may be greater than the first threshold or less than the first threshold. For example, the reference signal corresponding to the first TRP is less than the first threshold, and/or the reference signal corresponding to the second TRP is greater than the first threshold, or the reference signal corresponding to the second TRP is greater than the reference signal corresponding to the first TRP by a certain value, etc., which will be not limited in this embodiment. For example, the implementation of satisfying the first threshold may be selected according to the implementation of the actual measurement result and the setting of the first threshold, and the specific implementation of the first threshold may also be configured according to the actual situation.

In operation S702, the physical layer of the terminal device sends the measurement result to a network device in a first reporting manner.

Based on the above introduction, it may be determined that the physical layer of the terminal device may send the measurement result to the network device after the measurement result is obtained by performing the measurement. In one possible implementation, the measurement configuration information may also include the first reporting manner, and the first reporting manner includes at least one of: periodic reporting, aperiodic reporting or semi-persistent reporting.

The physical layer of the terminal device may, for example, send the measurement result to the network device in the first reporting manner. That is to say, the physical layer of the terminal device may periodically send the measurement result to the network device, or the physical layer may only send the measurement result obtained by the current single measurement to the network device, or the physical layer may also send the measurement result to the network device in a semi-persistent manner.

For the periodic reporting and the semi-persistent reporting, the specific reporting period may, for example, be indicated by the network device in the measurement configuration information, or may be pre-agreed by the network device and the terminal device, or may also be indicated in the protocol, which is not limited in this embodiment.

For example, the measurement and reporting performed by the physical layer in this embodiment may be understood with reference to FIG. 8. With reference to FIG. 8, the measurement in this embodiment is performed when the physical layer determines that the first measurement condition is satisfied, and the reporting in this embodiment is performed by the physical layer in the first reporting manner such as the periodic reporting, the aperiodic reporting or the semi-persistent reporting.

In operation S703, handover triggering indication information sent by the network device is received, where the handover triggering indication information includes an identifier of the second TRP and configuration information of the second TRP, and the handover triggering indication information is determined by the network device according to the measurement result.

After the physical layer of the terminal device sends the measurement result to the network device, the network device may determine, based on the measurement result reported by the terminal device, whether the handover is triggered. In one possible implementation, the network device may make a determination according to the information such as the measurement result, a cell load, a service type supported by the cell, whether the target cell agrees to handover. When it is determined that the handover is required to be triggered, the network device may generate handover triggering indication information. In this embodiment, the handover triggering indication information may, for example, indicate switching of the TRP connected with the terminal device from the first TRP into the second TRP.

In one possible implementation, the handover triggering indication information may include an identifier of the second TRP and configuration information of the second TRP. For example, the handover triggering indication information may include the MAC configuration, the RLC configuration, the PDCP configuration, the Data Radio Bearer (DRB) configuration, the security key configuration, the system message of the second TRP, such as SIB1, etc. The SIB is an abbreviation of System Information Block. In the actual implementation process, the specific implementation of the configuration information of the second TRP may be selected according to the actual requirements.

In addition, the handover triggering indication information in this embodiment may be transmitted to the terminal device through physical layer signaling, such as Downlink Control Information (DCI), or transmitted to the terminal device through an MAC CE, or through an RLC Control Protocol Data Unit (RLC control PDU) or a PDCP Control Protocol Data Unit (PDCP control PDU). The PDU is an abbreviation of Protocol Data Unit.

In operation S704, a TRP connected with the terminal device is switched from the first TRP into the second TRP according to the handover triggering indication information.

After the terminal device receives the handover triggering indication information, the terminal device may switch, according to the handover triggering indication information, the TRP connected with the terminal device from the first TRP into the second TRP.

The above introduction is the implementation for the network device to indicate the handover of the TRP. In another possible implementation, the handover of the TRP may be triggered by the terminal device, and after the handover, the handover indication information described above is generated and sent to the network device.

For example, the network layer of the terminal device may compare the measurement result with the corresponding threshold, so as to trigger the TRP connected with the terminal device to be switched from the first TRP into the second TRP, and generate the handover indication information. After the handover, the handover indication information may be generated and sent to the higher layer or the network device to inform the network device that the TRP connected with the current terminal device has been switched.

In one possible implementation, when the physical layer of the terminal device sends the measurement result or the handover indication information to the network device, for example, the measurement result or the handover indication information may be sent through the PUSCH or the PUCCH.

According to the handover method provided by the embodiment of the present disclosure, the reference signal corresponding to the first TRP and/or the second TRP may be measured when the physical layer determines that the first TRP and/or the second TRP satisfies the first measurement condition, to obtain the measurement result. The physical layer performs the periodic reporting, the aperiodic reporting or the semi-persistent reporting on the measurement result in the first reporting manner, so that the handover of the TRP may be triggered based on the handover triggering indication information sent by the network device; or the physical layer may directly trigger the handover and then send the handover indication information to the network device, thereby effectively implementing the bottom layer-based handover to effectively reduce the delay.

The above description is one possible implementation that the measurement and the reporting in the handover procedure are performed by the physical layer of the terminal device. The following is a description of another possible implementation that the measurement and the reporting are triggered by the physical layer with reference to FIG. 9 and FIG. 10.

As shown in FIG. 9, when the measurement and the reporting are triggered by the physical layer, the method includes operations S901 to S904.

In operation S901, a physical layer of a terminal device monitors a reference signal corresponding to a first TRP and/or a second TRP; and if it is determined that the reference signal corresponding to the first TRP and/or the second TRP satisfies a first measurement condition, the physical layer of the terminal device measures the reference signal corresponding to the first TRP and/or the second TRP, to obtain the measurement result.

The implementation of the operation S903 is the same as that introduced in the operation S701 above, which will not be described herein.

In operation S902, if it is determined that the reference signal corresponding to the first TRP and/or the second TRP satisfies a first reporting condition, the physical layer of the terminal device sends the measurement result to a network device.

Based on the above introduction, it may be determined that the physical layer of the terminal device may send the measurement result to the network device after the measurement result is obtained by performing the measurement. In one possible implementation, the measurement configuration information may also include the first reporting condition.

Then, the physical layer of the terminal device may, for example, determine whether the reference signal corresponding to the first TRP and/or the second TRP satisfies the first reporting condition, and when it is determined that the first reporting condition is satisfied, the physical layer of the terminal device may send the measurement result to the network device.

In one possible implementation, the first reporting condition may include, for example, a second threshold.
the fact that the reference signal corresponding to the first TRP and/or the second TRP satisfies the first reporting condition, for example, may include at least one of.
a measured value of the reference signal corresponding to the first TRP and/or the second TRP satisfies the second threshold; or
a difference between a measured value of the reference signal corresponding to the first TRP and a measured value of the reference signal corresponding to the second TRP satisfies the second threshold.

Similar to the introduction above, the satisfying the second threshold described in this embodiment, for example, may be greater than the second threshold or less than the second threshold, which is not limited in the embodiment. For example, the implementation of the satisfying the second threshold may be selected according to the implementation of the actual measurement result and the setting of the second threshold, and the specific implementation of the second threshold may also be configured according to the actual situation.

For example, the measurement and reporting by the physical layer in this embodiment may be understood with reference to FIG. 10. With reference to FIG. 10, the measurement in the embodiment is performed by the physical layer when it is determined that the first measurement condition is satisfied, and the reporting in the embodiment is performed by the physical layer when it is determined that the first reporting condition is satisfied.

In operation S903, handover triggering indication information sent by the network device is received, where the handover triggering indication information includes an identifier of the second TRP and configuration information of the second TRP, and the handover triggering indication information is determined by the network device according to the measurement result.

In operation S904, a TRP connected with the terminal device is switched from the first TRP into the second TRP according to the handover triggering indication information.

The implementations of the operation S903 and the operation S904 are similar to the implementations of the operation S703 and the operation S704 described above, which will not be described herein.

According to the handover method provided by the embodiment of the present disclosure, the reference signal corresponding to the first TRP and/or the second TRP may be measured when the physical layer determines that the first TRP and/or the second TRP satisfies the first measurement condition, to obtain the measurement result. When the physical layer determines that the first TRP and/or the second TRP satisfies the first reporting condition, the measurement result is reported to the network device, so that the handover of the TRP may be triggered based on the handover triggering indication information sent by the network device; or the physical layer may directly trigger the handover and then send the handover indication information to the network device, thereby effectively implementing the bottom layer-based handover to effectively reduce the delay.

On the basis of the above introduction, another possible implementation that the measurement and the reporting are triggered by the physical layer is introduced with reference to FIG. 11 and FIG. 12.

As shown in FIG. 11, when the measurement and the reporting are triggered by the physical layer, the method includes operations S1101 to S1102.

In operation S1101, a physical layer of a terminal device continuously measures a reference signal corresponding to a first TRP and/or a second TRP according to measurement configuration information sent by a network device, to obtain a measurement result.

In this embodiment, the physical layer of the terminal device may, for example, after receiving the measurement configuration information sent by the network device and according to the corresponding configuration in the measurement configuration information, continuously measure the reference signal corresponding to the first TRP and/or the second TRP, so as to obtain the measurement result.

In operation S1102, the physical layer of the terminal device sends the measurement result to the network device in a first reporting manner.

The implementation of the operation S1102 is similar to that of the operation S702 introduced above, which will not be repeated herein.

For example, the measurement and the reporting performed by the physical layer in this embodiment may be understood with reference to FIG. 12. With reference to FIG. 12, the measurement in this embodiment is continuously performed after the physical layer receives the measurement configuration information, and the reporting in this embodiment is performed by the physical layer in the first reporting manner such as the periodic reporting, the aperiodic reporting or the semi-persistent reporting.

In operation S1103, handover triggering indication information sent by the network device is received, where the handover triggering indication information includes an identifier of the second TRP and configuration information of the second TRP, and the handover triggering indication information is determined by the network device according to the measurement result.

In operation S1104, a TRP connected with the terminal device is switched from the first TRP into the second TRP according to the handover triggering indication information.

The implementations of the operation S1103 and the operation S1104 are similar to the implementations of the operation S703 and the operation S704 described above, which will not be described herein.

According to the handover method provided by the embodiment of the present disclosure, the reference signal corresponding to the first TRP and/or the second TRP may be continuously measured after the physical layer receives the measurement configuration information, to obtain the measurement result. The physical layer performs the periodic reporting, the aperiodic reporting or the semi-persistent reporting on the measurement result in the first reporting manner, so that the handover of the TRP may be triggered based on the handover triggering indication information sent by the network device; or the physical layer may directly trigger the handover and then send the handover indication information to the network device, thereby effectively implementing the bottom layer-based handover to effectively reduce the delay.

On the basis of the above introduction, another possible implementation that the measurement and the reporting are triggered by the physical layer is introduced with reference to FIG. 13 and FIG. 14.

As shown in FIG. 13, when the measurement and the reporting are triggered by the physical layer, the method includes operations 51301 to S1304.

In operation 51301, a physical layer of a terminal device continuously measures a reference signal corresponding to a first TRP and/or a second TRP according to a measurement configuration information sent by a network device, to obtain a measurement result.

The implementation of the operation 51301 is similar to that of the operation S1101 introduced above, which will not be repeated herein.

In operation S1302, if it is determined that the reference signal corresponding to the first TRP and/or the second TRP satisfies a first reporting condition, the physical layer of the terminal device sends the measurement result to the network device or the MAC layer.

The implementation of the operation S1302 is similar to that of the operation S902 introduced above, which will not be repeated herein.

For example, the measurement and the reporting performed by the physical layer in this embodiment may be understood with reference to FIG. 14. With reference to FIG. 14, the measurement in this embodiment is continuously performed after the physical layer receives the measurement configuration information, and the reporting in this embodiment is performed when the physical layer determines that the first reporting condition is satisfied.

In operation S1303, handover triggering indication information sent by the network device is received, where the handover triggering indication information includes an identifier of the second TRP and configuration information of the second TRP, and the handover triggering indication information is determined by the network device according to the measurement result.

In operation S1304, a TRP connected with the terminal device is switched from the first TRP into the second TRP according to the handover triggering indication information.

The implementations of the operation S1303 and the operation S1304 are similar to the implementations of the operation S703 and the operation S704 described above, which will not be described herein.

According to the handover method provided by the embodiment of the present disclosure, the reference signal corresponding to the first TRP and/or the second TRP may be continuously measured after the physical layer receives the measurement configuration information, to obtain the measurement result. When the physical layer determines that the first TRP and/or the second TRP satisfies the first reporting condition, the measurement result is reported to the network device, so that the handover of the TRP may be triggered based on the handover triggering indication information sent by the network device; or the physical layer may directly trigger the handover and then send the handover indication information to the network device, thereby effectively implementing the bottom layer-based handover to effectively reduce the delay.

The implementations that the handover procedure is triggered by the physical layer are described in combination with FIG. 7 to FIG. 14. In summary, in the implementation processes that handover is triggered by the physical layer, there are many different implementations for measuring the reference signal corresponding to the first TRP and/or the second TRP, and there are also many different implementations for reporting the measurement result, and different implementations of the measurement and different implementations of the reporting may be combined. Therefore, when the handover procedure is triggered by the physical layer, the flexibility of the implementation is high.

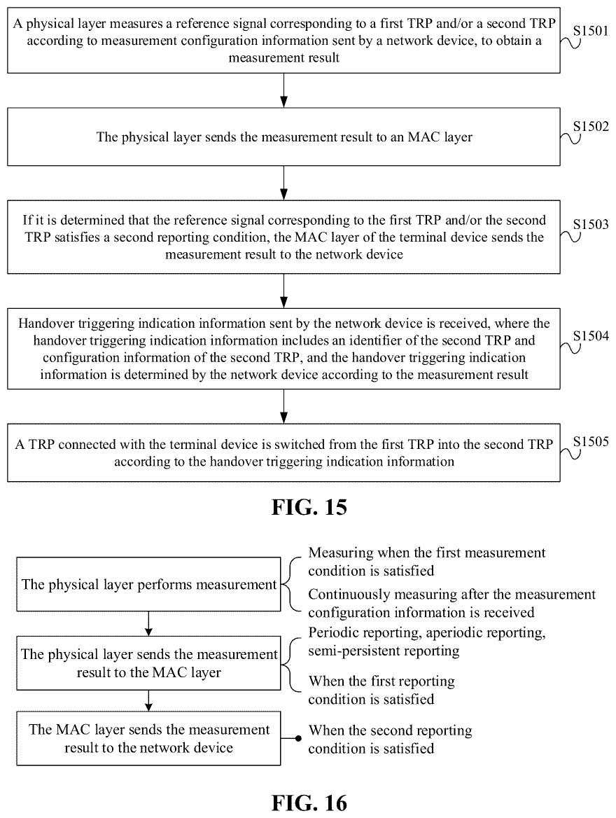

On the basis of the above introduction, it may be determined that the handover procedure may also be triggered by the MAC layer of the terminal device. The implementations that the handover procedure is triggered by the MAC layer are described below with reference to FIG. 15 to FIG. 16. FIG. 15 is a sixth flowchart of the handover method according to an embodiment of the present disclosure, and FIG. 16 is a schematic diagram of an implementation flow of the MAC layer according to an embodiment of the present disclosure.

As shown in FIG. 15, when the handover procedure is triggered by the MAC layer, the method includes operations S1501 to S1505.

In operation S1501, a physical layer measures a reference signal corresponding to a first TRP and/or a second TRP according to measurement configuration information sent by a network device, to obtain a measurement result.

In this embodiment, it is still the physical layer that measures the reference signal corresponding to the first TRP and/or the second TRP to obtain the measurement result. With reference to FIG. 16, the measurement performed by the physical layer may, for example, be the measurement performed on the reference signal corresponding to the first TRP and/or the second TRP when the first measurement condition is satisfied as described above. Alternatively, the measurement performed by the physical layer may be continuous measurement performed on the reference signal corresponding to the first TRP and/or the second TRP after the measurement configuration information is received The implementation of the measurement is not limited in the embodiment, and specific implementation of the measurement is similar to that described above, which will not be described herein.

In operation S1502, the physical layer sends the measurement result to an MAC layer.

In this embodiment, after the measurement result is obtained by measuring, the physical layer may send the measurement result to the MAC layer. With reference to FIG. 16, the physical layer sends the measurement result to the MAC layer. For example, in the first reporting manner described above, the physical layer may periodically send the measurement result to the MAC layer, or the physical layer may only send the measurement result obtained by the current single measurement to the MAC layer, or the physical layer may also send the measurement result to the MAC layer in a semi-persistent manner.

Optionally, when the physical layer sends the measurement result to the MAC layer, the physical layer may also send the measurement result to the MAC layer when it is determined that the reference signal corresponding to the first TRP and/or the second TRP satisfies the first reporting condition. The two implementations of sending the measurement result to MAC layer introduced herein are similar to the implementations of the physical layer sending the measurement result to the network device introduced above, which will not be repeated herein.

It is to be appreciated that the two measurement manners performed by the physical layer described above (i.e., the measurement performed when the first measurement condition is satisfied, and the continuous measurement performed after the measurement configuration information is received) and the two reporting manners for sending the measurement result to the MAC layer (i.e., periodic/aperiodic/semi-persistent reporting in the first reporting manner, and the reporting performed when it is determined that the first reporting condition is satisfied) may be combined according to actual requirements in the actual implementation process, and the combined implementations are similar to those described above. For example, the four combinations described in the above embodiments may be obtained, and each of the specific implementation may refer to the introduction of the above embodiments, which will not be repeated herein.

In operation S1503, if it is determined that the reference signal corresponding to the first TRP and/or the second TRP satisfies a second reporting condition, the MAC layer of the terminal device sends the measurement result to the network device.

After the physical layer sends the measurement result to the MAC layer, the MAC layer may obtain the measurement result, and then the MAC layer may send the measurement result to the network device, for example. In one possible implementation, the MAC layer may determine, for example, whether the reference signal corresponding to the first TRP and/or the second TRP satisfies the second reporting condition, and when it is determined that the second reporting condition is satisfied, the MAC layer of the terminal device may send the measurement result to the network device.

In one possible implementation, the second reporting condition includes a third threshold.

The fact that the reference signal corresponding to the first TRP and/or the second TRP satisfies the second reporting condition includes at least one of:
a measured value of the reference signal corresponding to the first TRP and/or the second TRP satisfies the third threshold;
a difference between a measured value of the reference signal corresponding to the first TRP and a measured value of the reference signal corresponding to the second TRP satisfies the third threshold;
measured values of the reference signal corresponding to the first TRP and/or the second TRP within a second preset duration all satisfy the third threshold;
differences between measured values of the reference signal corresponding to the first TRP and measured values of the reference signal corresponding to the second TRP within the second preset duration all satisfy the third threshold;
N consecutive measured values of the reference signal corresponding to the first TRP and/or the second TRP all satisfy the third threshold; or
differences between the N consecutive measured values of the reference signal corresponding to the first TRP and N consecutive measured values of the reference signal corresponding to the second TRP within the second preset duration all satisfy the third threshold. Herein, N is an integer greater than or equal to 1.

That is to say, when the MAC layer sends the measurement result to the network device, the MAC layer may report when the third threshold is satisfied for one time, or the MAC layer may also report when it is determined that the measurement results sent by the physical layer all satisfy the third threshold within the second preset duration, or the MAC layer may also report when it is determined that the measurement results sent by the physical layer for N consecutive times all satisfy the third threshold. The specific implementation of the reporting may be selected according to the actual requirements, which will not be limited in the embodiment.

Similar to the introduction above, the satisfying the third threshold described in this embodiment, for example, may be greater than the third threshold or less than the third threshold, which is not limited in the embodiment. For example, the implementation of the satisfying the third threshold may be selected according to the implementation of the actual measurement result and the setting of the third threshold, and the specific implementation of the third threshold, the second preset duration and the threshold of the number of times N may be configured according to the actual situation.

Alternatively, in another possible implementation, the measurement configuration information may also include a first reporting manner, and the first reporting manner includes at least one of: periodic reporting, aperiodic reporting or semi-persistent reporting. When the MAC layer sends the measurement result to the network device, for example, the MAC layer may send the measurement result to the network device according to the first reporting manner, and the implementation thereof is similar to the implementation introduced in the above embodiment, which will not be repeated herein.

In operation S1504, handover triggering indication information sent by the network device is received, where the handover triggering indication information includes an identifier of the second TRP and configuration information of the second TRP, and the handover triggering indication information is determined by the network device according to the measurement result.

Similar to the above embodiment, the network device may determine, according to the measurement result reported by the terminal device, whether the handover is triggered. When it is determined that the handover is required to be triggered, the network device may generate the handover triggering indication information. For example, the handover triggering indication information in this embodiment may indicate switching of the TRP connected with the terminal device from the first TRP into the second TRP.

In one possible implementation, the handover triggering indication information may include the identifier of the second TRP and the configuration information of the second TRP. For example, the handover triggering indication information may include the MAC configuration, the RLC configuration, the PDCP configuration, the DRB configuration, the security key configuration, the system message of the second TRP, such as SIB1, etc. In the actual implementation process, the specific implementation of the configuration information of the second TRP may be selected according to the actual requirements.

In addition, the handover triggering indication information in this embodiment may be transmitted to the terminal device through physical layer signaling, such as DCI, or transmitted to the terminal device through MAC CE, or through the RLC control PDU or the PDCP control PDU.

In operation S1505, a TRP connected with the terminal device is switched from the first TRP into the second TRP according to the handover triggering indication information.

As described above, after the terminal device receives the handover triggering indication information, the terminal device may switch, according to the handover triggering indication information, the TRP connected with the terminal device from the first TRP into the second TRP.

The implementations of the network device indicating the handover of the TRP are described above. In another possible implementation, the handover of the TRP may be triggered by the terminal device, and after the handover, the handover indication information described above is generated and sent to the network device.

For example, the MAC layer of the terminal device may compare the measurement result with the corresponding threshold, thereby triggering the TRP connected with the terminal device to be switched from the first TRP into the second TRP; and generate the handover indication information. After the handover, the handover indication information may be generated and sent to the higher layer or the network device to inform the network device that the current TRP connected with the terminal device has been switched.

In one possible implementation, the MAC layer of the terminal device may send the measurement result or the handover indication information to the network device, for example, through the MAC CE.

According to the handover method provided by the embodiment of the present disclosure, the physical layer may measure the reference signal corresponding to the first TRP and/or the second TRP to obtain the measurement result and send the measurement result to the MAC layer. Then the MAC layer may report the measurement result to the network device when it is determined that the first TRP and/or the second TRP satisfies the second reporting condition, so that the handover of the TRP may be triggered based on the handover triggering indication information sent by the network device; or the MAC layer may directly trigger the handover and then send the handover indication information to the network device, thereby effectively implementing the bottom layer-based handover to effectively reduce the delay.

The implementations that the handover is triggered by the physical layer and the MAC layer are described in the above embodiments. In another possible implementation, the terminal device may also determine, based on the BFR process, whether the handover is triggered. For example, when the terminal device triggers the beam failure recovery process, and the beam satisfying a corresponding threshold is of an adjacent cell, i.e., the beam corresponding to the second TRP, the terminal device may trigger the handover procedure at this case.

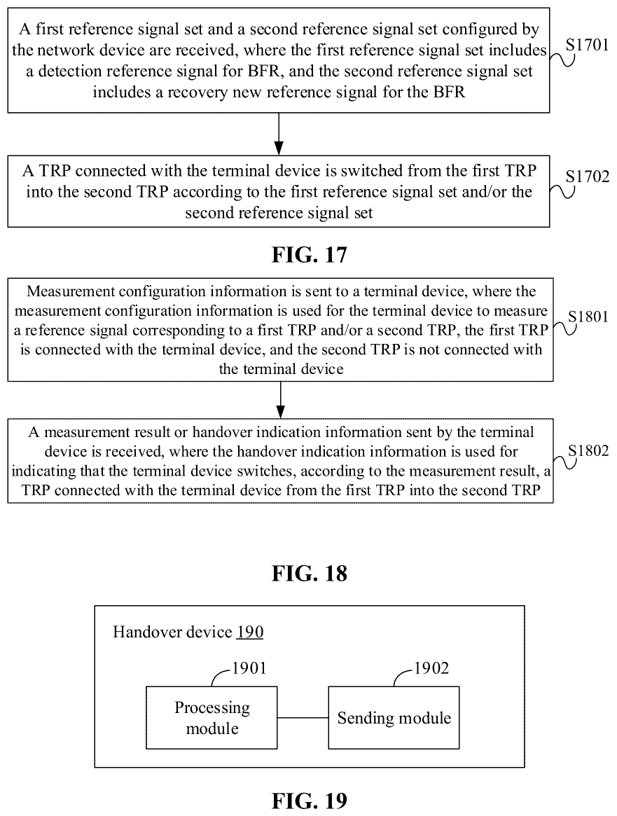

For example, the implementation that the terminal device determines, based on the BFR process, whether the handover is triggered may be understood with reference to FIG. 17. FIG. 17 is a seventh flowchart of a handover method according to an embodiment of the present disclosure.

In operation S1701, a first reference signal set and a second reference signal set configured by the network device are received, where the first reference signal set includes a detection reference signal for BFR, and the second reference signal set includes a recovery new reference signal for the BFR.

Specifically, the network device may configure the beam failure detection reference signal set (the first reference signal set) for the beam failure recovery and the new reference signal set for the beam failure recovery (the second reference signal set) for the terminal device. In the first reference signal set, there may be both the reference signal corresponding to the first TRP and the reference signal corresponding to the second TRP. In the second reference signal set, there may also be both the reference signal corresponding to the first TRP and the reference signal corresponding to the second TRP. The reference signals in the first reference signal set and the second reference signal set depend on the specific configuration of the network device, which will not be limited in this embodiment.

In operation S1702, a TRP connected with the terminal device is switched from the first TRP into the second TRP according to the first reference signal set and/or the second reference signal set.

The terminal device may then switch the TRP connected with the terminal device from the first TRP into the second TRP according to the first reference signal set and/or the second reference signal set.

In one possible implementation, if the first reference signal set and/or the second reference signal set satisfies a first preset condition, the terminal device may send reporting information to the network device.

The reporting information may be used to for indicating that the current first reference signal set and/or the second reference signal set satisfies the first preset condition. According to the reporting information, the network device may determine that the first reference signal set and/or the second reference signal set satisfies the first preset condition, so that it is determined that the TRP connected with the current terminal device may be switched from the first TRP into the second TRP, and then the network device may send the handover triggering indication information to the terminal device. The handover triggering indication information is similar to that introduced in the above embodiment, which will not be repeated herein.

Then, the terminal device receives the handover triggering indication information sent by the network device, where the handover triggering indication information is used for indicating switching of the TRP connected with the terminal device from the first TRP into the second TRP.

Herein, the implementation that the terminal device reports to the network device and the network device triggers the handover is introduced. In another possible implementation, the terminal device may also trigger the handover by itself.

Specifically, if the first reference signal set and/or the second reference signal set satisfies the first preset condition, the physical layer or the MAC layer triggers the TRP connected with the terminal device to be switched from the first TRP into the second TRP, and generates the handover indication information.

The first preset described above may, for example, be that a beam satisfying the fourth threshold exists in the second reference signal set, and the beam satisfying the fourth threshold is a beam of the second TRP.

The measurement configuration information may also include, for example, the fourth threshold, where the fourth threshold is a threshold for indicating whether the beam failure occurs, which may be, for example, the hypothetical BLER performance is poor than the threshold as described above. It is also to be understood that the first reference signal set includes a reference signal for the beam failure detection and the second reference signal set includes a new reference signal for the beam failure recovery. That is to say, a new available beam may be found in the second reference signal set when the beam failure of the first TRP is currently determined.

Therefore, it may be determined whether the beam satisfying the fourth threshold exists in the second reference signal set; if so, it may be further determined whether the beam satisfying the fourth threshold is the beam of the second TRP; if so, the TRP connected with the terminal may be triggered to be switched from the first TRP into the second TRP.

The first preset condition described above, for example, may further be that when the terminal device performs beam failure detection, all beams not satisfying the fourth threshold are beams of the first TRP.

It is to be understood that if all beams not satisfying the fourth threshold are beams of the first TRP when the beam failure detection is performed, i.e., all the bad beams are beams of the first TRP, then the first TRP cannot be used any more in this case, so the TRP connected with the terminal may be triggered to be switched from the first TRP into the second TRP.

According to the handover method provided by the embodiment of the present disclosure, the network device configures the first reference signal set and/or the second reference signal set for the terminal device, so that the TRP connected with the terminal device may be directly triggered to be switched from the first TRP into the second TRP when it is determined that the first preset condition is satisfied in the BFR process. In this way, the handover may be implemented without the multiple signaling interactions, so as to effectively reduce the delay in the handover procedure.

Each of the above-mentioned embodiments describes an implementation on the terminal device side, and the implementation on the network device side is described below with reference to FIG. 18. FIG. 18 is an eighth flowchart of a handover method according to an embodiment of the present disclosure.

As shown in FIG. 18, the method includes operations S1801 to S1802.

In operation S1801, measurement configuration information is sent to a terminal device, where the measurement configuration information is used for the terminal device to measure a reference signal corresponding to a first TRP and/or a second TRP, the first TRP is connected with the terminal device, and the second TRP is not connected with the terminal device.

The network device may send the measurement configuration information to the terminal device, and then the terminal device may measure the reference signal corresponding to the first TRP and/or the second TRP according to the measurement configuration information, so as to obtain the measurement result. The specific implementation is similar to that described above, which will not be described herein.

In operation S1802: a measurement result or handover indication information sent by the terminal device is received, where the handover indication information is used for indicating that the terminal device switches, according to the measurement result, a TRP connected with the terminal device from the first TRP into the second TRP.

Then, the network device may, for example, receive the measurement result sent by the terminal device, and then determine whether the handover from the first TRP into the second TRP is required to be performed according to the measurement result. Alternatively, the terminal device may trigger the handover by itself, and then the network device may receive the handover indication information sent by the terminal device, and the handover indication information is used for informing the network device that the terminal device switches the TRP connected with the terminal device from the first TRP into the second TRP according to the measurement result.

The various possible implementations on the network device side are similar to those described in the embodiments of the terminal device side described above, which will not be repeated herein.

The handover method provided by the embodiment of the present disclosure includes that: measurement configuration information is sent to a terminal device, where the measurement configuration information is used for the terminal device to measure a reference signal corresponding to a first TRP and/or a second TRP, the first TRP is connected with the terminal device, and the second TRP is not connected with the terminal device; a measurement result or handover indication information sent by the terminal device is received, where the handover indication information is used for indicating that the terminal device switches, according to the measurement result, a TRP connected with the terminal device from the first TRP into the second TRP. The measurement configuration information is sent to the terminal device, so that the terminal device measures, according to the measurement configuration information, the first TRP and/or the second TRP configured by the network device, to obtain the measurement result. And then, the network device or the terminal device implement, based on the measurement result, the handover of the terminal device from the first TRP into the second TRP when corresponding conditions are satisfied, so that the interaction procedure of multiple pieces of signaling can be effectively avoided, thereby reducing the handover delay.

FIG. 19 is a schematic structural diagram of a handover device according to an embodiment of the present disclosure. With reference to FIG. 19, the handover device 190 may include a processing module 1901 and a sending module 1902.

The processing module 1901 is configured to measure, according to measurement configuration information sent by a network device, a reference signal corresponding to a first TRP and/or a second TRP to obtain a measurement result, where the first TRP is connected with the terminal device, and the second TRP is not connected with the terminal device.

The sending module 1902 is configured to send the measurement result or handover indication information to the network device, where the handover indication information is used for indicating that the terminal device switches, according to the measurement result, a TRP connected with the terminal device from the first TRP into the second TRP.

In one possible implementation, the processing module 1901 is specifically configured to:
monitor, through a physical layer of the terminal device, the reference signal corresponding to the first TRP and/or the second TRP; and if it is determined that the reference signal corresponding to the first TRP and/or the second TRP satisfies the first measurement condition, measure, through the physical layer of the terminal device, the reference signal corresponding to the first TRP and/or the second TRP.

In one possible implementation, the processing module 1901 is specifically configured to:
if it is determined that a duration where the reference signal corresponding to the first TRP and/or the second TRP satisfies the first measurement condition is greater than or equal to a first preset duration, measure, through the physical layer of the terminal device, the reference signal corresponding to the first TRP and/or the second TRP.

In one possible implementation, the first measurement condition includes a first threshold,
where a fact that the reference signal corresponding to the first TRP and/or the second TRP satisfies the first measurement condition includes at least one of:
a measured value of the reference signal corresponding to the first TRP and/or the second TRP satisfies the first threshold; or
a difference between a measured value of the reference signal corresponding to the first TRP and a measured value of the reference signal corresponding to the second TRP satisfies the first threshold.

In one possible implementation, the processing module 1901 is specifically configured to:
continuously measure, through a physical layer of the terminal device according to the measurement configuration information sent by the network device, the reference signal corresponding to the first TRP and/or the second TRP.

In one possible implementation, the sending module 1902 is specifically configured to:
send, through a physical layer of the terminal device, the measurement result to the network device; or
send, through a Media Access Control (MAC) layer of the terminal device, the measurement result to the network device, where the measurement result sent by the MAC layer is sent by the physical layer to the MAC layer.

In one possible implementation embodiment, the measurement configuration information includes a first reporting manner, and the first reporting manner includes at least one of: periodic reporting, aperiodic reporting and semi-persistent reporting.

The sending module 1902 is specifically configured to:
send, through the physical layer of the terminal device, the measurement result to the network device or the MAC layer in the first reporting manner.

In one possible implementation, the measurement configuration information includes a first reporting condition, and the sending module 1902 is specifically configured to:
if it is determined that the reference signal corresponding to the first TRP and/or the second TRP satisfies the first reporting condition, send, through the physical layer of the terminal device, the measurement result to the network device or the MAC layer.

In one possible implementation, the first reporting condition includes a second threshold,
where a fact that the reference signal corresponding to the first TRP and/or the second TRP satisfies the first reporting condition includes at least one of:
a measured value of the reference signal corresponding to the first TRP and/or the second TRP satisfies the second threshold; or
a difference between a measured value of the reference signal corresponding to the first TRP and a measured value of the reference signal corresponding to the second TRP satisfies the second threshold.

In one possible implementation, the physical layer sends the measurement result to the network device through a PUSCH or a PUCCH.

In one possible implementation, the measurement configuration information includes a second reporting condition, and the sending module 1902 is specifically configured to:
if it is determined that the reference signal corresponding to the first TRP and/or the second TRP satisfies the second reporting condition, send, through the MAC layer of the terminal device, the measurement result to the network device.

In one possible implementation, the second reporting condition includes a third threshold,
where a fact that the reference signal corresponding to the first TRP and/or the second TRP satisfies the second reporting condition includes at least one of:
a measured value of the reference signal corresponding to the first TRP and/or the second TRP satisfies the third threshold;
a difference between a measured value of the reference signal corresponding to the first TRP and a measured value of the reference signal corresponding to the second TRP satisfies the third threshold; or
measured values of the reference signal corresponding to the first TRP and/or the second TRP within a second preset duration all satisfy the third threshold;
differences between measured values of the reference signal corresponding to the first TRP and measured values of the reference signal corresponding to the second TRP within the second preset duration all satisfy the third threshold;
N consecutive measured values of the reference signal corresponding to the first TRP and/or the second TRP all satisfy the third threshold; or
differences between the N consecutive measured values of the reference signal corresponding to the first TRP and N consecutive measured values of the reference signal corresponding to the second TRP within the second preset duration all satisfy the third threshold,
where N is an integer greater than or equal to 1.

In one possible implementation, the MAC layer sends the measurement result to the network device through an MAC CE.

In one possible implementation, the processing module 1901 is further configured to:
after the measurement result is sent to the network device, receive handover triggering indication information sent by the network device, where the handover triggering indication information includes an identifier of the second TRP and configuration information of the second TRP, and the handover triggering indication information is determined by the network device according to the measurement result; and
switch, according to the handover triggering indication information, the TRP connected with the terminal device from the first TRP into the second TRP.

In one possible implementation, the handover triggering indication information is transmitted through physical layer signaling; or the handover triggering indication information is transmitted through the MAC CE.

In one possible implementation, the processing module 1901 is further configured to:
after the reference signal corresponding to the first TRP and/or the second TRP is measured according to the measurement configuration information sent by the network device to obtain the measurement result, trigger, through the physical layer of the terminal device according to the measurement result, the TRP connected with the terminal device to be switched from the first TRP into the second TRP, and generate the handover indication information.

In one possible implementation, the processing module 1901 is further configured to:
after the reference signal corresponding to the first TRP and/or the second TRP is measured according to the measurement configuration information sent by the network device to obtain the measurement result, trigger, through the MAC layer of the terminal device according to the measurement result, the TRP connected with the terminal device to be switched from the first TRP into the second TRP, and generate the handover indication information.

In one possible implementation, the processing module 1901 is further configured to:
receive a first reference signal set and a second reference signal set configured by the network device, where the first reference signal set includes a detection reference signal for Beam Failure Recovery (BFR), and the second reference signal set includes a recovery new reference signal for the BFR; and
switch, according to the first reference signal set and/or the second reference signal set, the TRP connected with the terminal device from the first TRP into the second TRP.

In one possible implementation, the processing module 1901 is specifically configured to:
if the first reference signal set and/or the second reference signal set satisfies a first preset condition, send reporting information to the network device; and
receive the handover triggering indication information sent by the network device, where the handover triggering indication information is used for indicating switching of the TRP connected with the terminal device from the first TRP into the second TRP.

In one possible implementation, the processing module 1901 is specifically configured to:
if the first reference signal set and/or the second reference signal set satisfies a first preset condition, trigger, through the physical layer or the MAC layer, the TRP connected with the terminal device to be switched from the first TRP into the second TRP, and generate the handover indication information.

In one possible implementation, the measurement configuration information includes a fourth threshold, and the first preset condition includes at least one of:
a beam satisfying the fourth threshold exists in the second reference signal set, and the beam satisfying the fourth threshold is a beam of the second TRP; or
when the terminal device performs beam failure detection, all beams not satisfying the fourth threshold are beams of the first TRP.

The handover device provided by the embodiment of the present disclosure may perform the technical schemes shown in the method embodiment above, and its implementation principle and beneficial effect are similar to the method embodiment above, which will not be repeated herein.

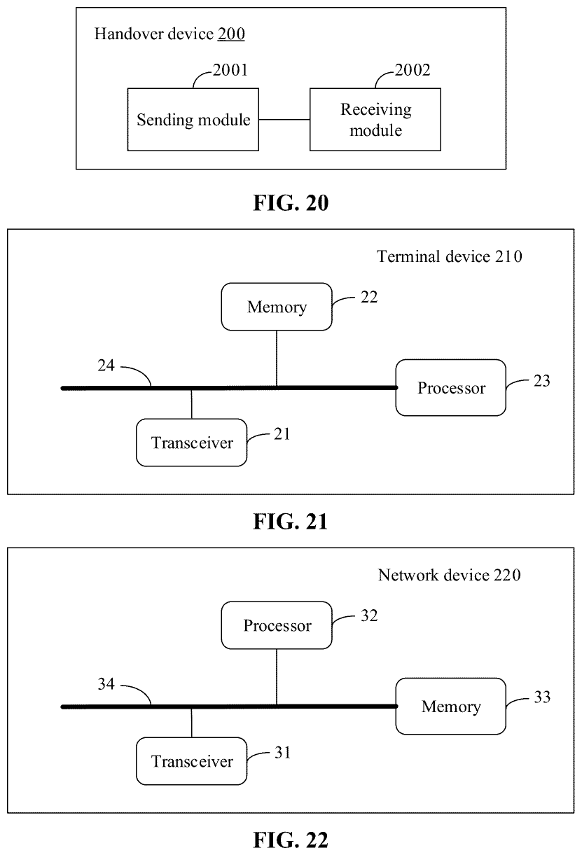

FIG. 20 is a schematic structural diagram of a handover device according to an embodiment of the present disclosure. With reference to FIG. 20, the handover device 200 may include a sending module 2001 and a receiving module 2002.

The sending module 2001 is configured to send measurement configuration information to a terminal device, where the measurement configuration information is used for the terminal device to measure a reference signal corresponding to a first Transmission/Reception Point (TRP) and/or a second TRP, the first TRP is connected with the terminal device, and the second TRP is not connected with the terminal device.

The receiving module 2002 is configured to receive a measurement result or handover indication information sent by the terminal device, where the handover indication information is used for indicating that the terminal device switches, according to the measurement result, a TRP connected with the terminal device from the first TRP into the second TRP.

In one possible implementation, the measurement configuration information includes a first measurement condition, and the first measurement condition is used for a physical layer of the terminal device to measure the reference signal corresponding to the first TRP and/or the second TRP when the physical layer determines that the reference signal corresponding to the first TRP and/or the second TRP satisfies the first measurement condition.

In one possible implementation, the first measurement condition is used for the physical layer of the terminal device to measure the reference signal corresponding to the first TRP and/or the second TRP when it is determined that a duration where the reference signal corresponding to the first TRP and/or the second TRP satisfies the first measurement condition is greater than or equal to a first preset duration.

In one possible implementation, the first measurement condition includes a first threshold,
where a fact that the reference signal corresponding to the first TRP and/or the second TRP satisfies the first measurement condition includes at least one of:
a measured value of the reference signal corresponding to the first TRP and/or the second TRP satisfies the first threshold; or
a difference between a measured value of the reference signal corresponding to the first TRP and a measured value of the reference signal corresponding to the second TRP satisfies the first threshold.

In one possible implementation, the measurement configuration information is used for a physical layer of the terminal device to continuously measure, according to the measurement configuration information, the reference signal corresponding to the first TRP and/or the second TRP.

In one possible implementation, the receiving module 2002 is specifically configured to:
receive the measurement result sent by the physical layer of the terminal device; or
receive the measurement result sent by a Media Access Control (MAC) layer of the terminal device, where the measurement result sent by the MAC layer is sent by the physical layer to the MAC layer.

In one possible implementation, the measurement configuration information includes a first reporting manner, and the first reporting manner includes at least one of: periodic reporting, aperiodic reporting and semi-persistent reporting,
where the receiving module 2002 is specifically configured to:
receive the measurement result sent by the physical layer of the terminal device in the first reporting manner.

In one possible implementation, the measurement configuration information includes a first reporting condition, and the measurement result sent by the physical layer of the terminal device is sent to the network device when it is determined that the reference signal corresponding to the first TRP and/or the second TRP satisfies the first reporting condition.

In one possible implementation, the first reporting condition includes a second threshold,
where a fact that the reference signal corresponding to the first TRP and/or the second TRP satisfies the first reporting condition includes at least one of:
a measured value of the reference signal corresponding to the first TRP and/or the second TRP satisfies the second threshold; or
a difference between a measured value of the reference signal corresponding to the first TRP and a measured value of the reference signal corresponding to the second TRP satisfies the second threshold.

In one possible implementation, where the measurement result is sent by the physical layer through a PUSCH or a PUCCH.

In one possible implementation, the measurement configuration information includes a second reporting condition, and the measurement result sent by the MAC layer of the terminal device is sent to the network device when it is determined that the reference signal corresponding to the first TRP and/or the second TRP satisfies the second reporting condition.

In one possible implementation, the second reporting condition includes a third threshold;
where a fact that the reference signal corresponding to the first TRP and/or the second TRP satisfies the second reporting condition includes at least one of:
a measured value of the reference signal corresponding to the first TRP and/or the second TRP satisfies the third threshold;
a difference between a measured value of the reference signal corresponding to the first TRP and a measured value of the reference signal corresponding to the second TRP satisfies the third threshold; or
measured values of the reference signal corresponding to the first TRP and/or the second TRP within a second preset duration all satisfy the third threshold;
differences between measured values of the reference signal corresponding to the first TRP and measured values of the reference signal corresponding to the second TRP within the second preset duration all satisfy the third threshold;
N consecutive measured values of the reference signal corresponding to the first TRP and/or the second TRP all satisfy the third threshold; or
differences between the N consecutive measured values of the reference signal corresponding to the first TRP and N consecutive measured values of the reference signal corresponding to the second TRP within the second preset duration all satisfy the third threshold,
where N is an integer greater than or equal to 1.

In one possible implementation, where the measurement result is sent by the MAC layer through an MAC CE.

In one possible implementation, the sending module 2001 is further configured to:
after the measurement result sent by the terminal device is received, determine handover triggering indication information according to the measurement result, where the handover triggering indication information includes an identifier of the second TRP and configuration information of the second TRP, and the handover triggering indication information is used for indicating switching of the TRP connected with the terminal device from the first TRP into the second TRP; and
send the handover triggering indication information to the terminal device.

In one possible implementation, the handover triggering indication information is transmitted through physical layer signaling; or the handover triggering indication information is transmitted through an MAC CE.

In one possible implementation, switching the TRP connected with the terminal device from the first TRP into the second TRP is triggered by the physical layer of the terminal device according to the measurement result.

In one possible implementation, switching the TRP connected with the terminal device from the first TRP into the second TRP is triggered by the MAC layer of the terminal device according to the measurement result.

In one possible implementation, the sending module 2001 is further configured to:
configure a first reference signal set and a second reference signal set for the terminal device, where the first reference signal set includes a detection reference signal for BFR, and the second reference signal set includes a recovery new reference signal for the BFR.

In one possible implementation, the receiving module 2002 is further configured to:
after the first reference signal set and the second reference signal set are configured for the terminal device, receive reporting information sent by the terminal device, where the reporting information is used for indicating that the first reference signal set and/or the second reference signal set satisfies a first preset condition; and
the sending module 2001 is also configured to send the handover triggering indication information to the terminal device, where the handover triggering indication information is used for indicating switching of the TRP connected with the terminal device from the first TRP into the second TRP.

In one possible implementation, switching the TRP connected with the terminal device from the first TRP into the second TRP is triggered by the physical layer or the MAC layer when it is determined that the first reference signal set and/or the second reference signal set satisfies a first preset condition.

In one possible implementation, the measurement configuration information includes a fourth threshold, and the first preset condition includes at least one of:
a beam satisfying the fourth threshold exists in the second reference signal set, and the beam satisfying the fourth threshold is a beam of the second TRP; or
when the terminal device performs beam failure detection, all beams not satisfying the fourth threshold are beams of the first TRP.

The handover device provided by the embodiment of the present disclosure may perform the technical schemes shown in the method embodiment above, and its implementation principle and beneficial effect are similar to the method embodiment above, which will not be repeated herein.

FIG. 21 is a schematic structural diagram of a terminal device according to an embodiment of the present disclosure. With reference to FIG. 21, the terminal device 210 may include a transceiver 21, a memory 22 and a processor 23. The transceiver 21 may include a transmitter and/or a receiver. The transmitter may also be referred to as sender, transmitting device, transmitting port or transmitting interface or the like, and the receiver may also be referred to as receiving device, receiving port or receiving interface or the like. Exemplarily, various parts of the transceiver 21, the memory 22 and the processor 23 are connected with each other via a bus 24.

The memory 22 is configured to store program instructions.

The processor 23 is configured to execute the program instructions stored in the memory, to enable the terminal device 150 to perform any handover method shown above.

The receiver of the transceiver 21 may be configured to perform the reception function of the terminal device in the resource processing method.

FIG. 22 is a schematic structural diagram of a network device according to an embodiment of the present disclosure. With reference to FIG. 22, the network device 220 may include a transceiver 31, a memory 32 and a processor 33. The transceiver 31 may include a transmitter and/or receiver. The transmitter may also be referred to as sender, transmitting device, transmitting port or transmitting interface or the like, and the receiver may also be referred to as receiving device, receiving port or receiving interface or the like. Exemplarily, various parts of the transceiver 31, the memory 32 and the processor 33 are connected with each other via a bus 34.

The memory 32 is configured to store program instructions.

The processor 33 is configured to execute the program instructions stored in the memory, to enable the network device 160 to perform any handover method shown above.

The receiver of the transceiver 31 may be configured to perform the reception function of the network device in the resource processing method.

The embodiments of the present disclosure provide a computer-readable storage medium having computer-executable instructions stored thereon, the handover method is implemented when the computer-executable instructions are executed by a processor.

The embodiments of the present disclosure may also provide a computer program product executable by a processor. When the computer program product is executed, the handover method performed by the terminal device or the network device as described above may be implemented.

The terminal device, the computer-readable storage medium and the computer program product of the embodiments of the present disclosure may perform the handover method introduced in the above embodiments, and the specific implementation process and beneficial effects thereof are referred to above, which will not be described herein.

In some embodiments provided by the disclosure, it is to be understood that the disclosed system, apparatus, and method may be implemented in another manner. For example, the apparatus embodiment described above is only schematic. For example, division of the units is only logic function division, and other division manners may be adopted during practical implementation. For example, multiple units or components may be combined or integrated into another system, or some characteristics may be neglected or not executed. In addition, coupling or direct coupling or communication connection between displayed or discussed components may be indirect coupling or communication connection, implemented through some interfaces, of the apparatus or the units, and may be electrical and mechanical or adopt other forms.

The units described as separate parts may or may not be physically separated, and parts displayed as units may or may not be physical units, namely they may be located in the same place, or may be distributed to multiple network units. Part or all of the units may be selected to achieve the purposes of the solutions of the embodiments according to a practical requirement. On the other hand, the mutual coupling or direct coupling or communication connection illustrated or discussed can be indirect coupling or communication connection through some interfaces, devices or units, and can be electric, mechanical or other forms.

It will be appreciated by those of ordinary skill in the art that all or a portion of the operations of the above-described method embodiments may be implemented by means of hardware associated with program instructions. The above-described program may be stored in a computer-readable storage medium. The program, when executed by the processor, performs the operations of the above-described method embodiments. The storage medium includes a removable storage device, a Read Only Memory (ROM), a Random Access Memory (RAM), a magnetic disk, or an optical disk and other media that can store program codes.

Finally, it is to be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without making the essence of the corresponding technical solutions depart from the scope of the technical solutions of the embodiments of the present disclosure.

1. A handover method, applied to a terminal device, comprising:
measuring, according to measurement configuration information sent by a network device, a reference signal corresponding to a first Transmission/Reception Point (TRP) and/or a second TRP to obtain a measurement result, wherein the first TRP is connected with the terminal device, and the second TRP is not connected with the terminal device; and
sending the measurement result to the network device.

2. The method of claim 1, wherein measuring, according to the measurement configuration information sent by the network device, the reference signal corresponding to the first TRP and/or the second TRP comprises:
continuously measuring, by a physical layer of the terminal device according to the measurement configuration information sent by the network device, the reference signal corresponding to the first TRP and/or the second TRP.

3. The method of claim 1, wherein sending the measurement result to the network device comprises:
sending, by a physical layer of the terminal device, the measurement result to the network device.

4. The method of claim 3, wherein the measurement configuration information comprises a first reporting manner, and the first reporting manner comprises at least one of: periodic reporting, aperiodic reporting or semi-persistent reporting.

5. The method of claim 3, wherein the physical layer sends the measurement result to the network device through a Physical Uplink Shared Channel (PUSCH) or a Physical Uplink Control Channel (PUCCH).

6. The method of claim 1, further comprising: after sending the measurement result to the network device,
receiving handover triggering indication information sent by the network device, wherein the handover triggering indication information comprises an identifier of the second TRP and configuration information of the second TRP, and the handover triggering indication information is determined by the network device according to the measurement result; and
switching, according to the handover triggering indication information, the TRP connected with the terminal device from the first TRP into the second TRP.

7. The method of claim 6, wherein the handover triggering indication information is transmitted through physical layer signaling; or the handover triggering indication information is transmitted through an MAC CE.

8. A handover device, applied to a terminal device, comprising:
a processor, a memory and a transceiver, wherein the memory is configured to store computer-executable instructions; and the processor is configured to invoke and run the computer-executable instructions stored in the memory to perform operations of:
measuring, according to measurement configuration information sent by a network device, a reference signal corresponding to a first Transmission/Reception Point (TRP) and/or a second TRP to obtain a measurement result, wherein the first TRP is connected with the terminal device, and the second TRP is not connected with the terminal device; and
sending, through the transceiver, the measurement result to the network device.

9. The device of claim 8, wherein measuring, according to the measurement configuration information sent by the network device, the reference signal corresponding to the first TRP and/or the second TRP comprises:
continuously measuring, through a physical layer of the terminal device according to the measurement configuration information sent by the network device, the reference signal corresponding to the first TRP and/or the second TRP.

10. The device of claim 8, wherein sending, through the transceiver, the measurement result to the network device comprises:
sending, through a physical layer of the terminal device, the measurement result to the network device.

11. The device of claim 10, wherein the measurement configuration information comprises a first reporting manner, and the first reporting manner comprises at least one of: periodic reporting, aperiodic reporting and semi-persistent reporting.

12. The device of claim 10, wherein the physical layer sends the measurement result to the network device through a Physical Uplink Shared Channel (PUSCH) or a Physical Uplink Control Channel (PUCCH).

13. The device of claim 8, wherein the processor is configured to invoke and run the computer-executable instructions stored in the memory to further perform operations of:
after the measurement result is sent to the network device, receiving handover triggering indication information sent by the network device, wherein the handover triggering indication information comprises an identifier of the second TRP and configuration information of the second TRP, and the handover triggering indication information is determined by the network device according to the measurement result; and
switching, according to the handover triggering indication information, the TRP connected with the terminal device from the first TRP into the second TRP.

14. The device of claim 13, wherein the handover triggering indication information is transmitted through physical layer signaling; or the handover triggering indication information is transmitted through an MAC CE.

15. A handover device, applied to a network device, comprising:
a processor, a memory and a transceiver, wherein the memory is configured to store computer-executable instructions; and the processor is configured to invoke and run the computer-executable instructions stored in the memory to perform operations of:
sending measurement configuration information to a terminal device, wherein the measurement configuration information is used for the terminal device to measure a reference signal corresponding to a first Transmission/Reception Point (TRP) and/or a second TRP, the first TRP is connected with the terminal device, and the second TRP is not connected with the terminal device; and
receiving, through the transceiver, a measurement result sent by the terminal device.

16. The device of claim 15, wherein the measurement configuration information is used for a physical layer of the terminal device to continuously measure, according to the measurement configuration information, the reference signal corresponding to the first TRP and/or the second TRP.

17. The device of claim 15, wherein receiving, through the transceiver, the measurement result sent by the terminal device:
receiving the measurement result sent by the physical layer of the terminal device.

18. The device of claim 17, wherein the measurement configuration information comprises a first reporting manner, and the first reporting manner comprises at least one of: periodic reporting, aperiodic reporting and semi-persistent reporting.

19. The device of claim 17, wherein the measurement result is sent by the physical layer through a Physical Uplink Shared Channel (PUSCH) or a Physical Uplink Control Channel (PUCCH).

20. The device of claim 15, wherein the processor is configured to invoke and run the computer-executable instructions stored in the memory to further perform operations of:
after the measurement result sent by the terminal device is received, determining handover triggering indication information according to the measurement result, wherein the handover triggering indication information comprises an identifier of the second TRP and configuration information of the second TRP, and the handover triggering indication information is used for indicating switching of the TRP connected with the terminal device from the first TRP into the second TRP; and
sending the handover triggering indication information to the terminal device.
